(19) United States
(12) Patent Application Publication
(10) Pub. No.: US 2022/0414606 A1
(43) Pub. Date: Dec. 29, 2022

(54) METHOD AND SYSTEM FOR MONITORING AND MANAGING PAID TIME OFF FOR EMPLOYEES

(71) Applicant: LETS SHIFT LTD, Hod Hasharon (IL)

(72) Inventors: Veetahl EILAT-RAICHEL, Hod Hasharon (IL); Eliaz SHAPIRA, Hod Hasharon (IL)

(73) Assignee: LETS SHIFT LTD, Hod Hasharon (IL)

(21) Appl. No.: 17/356,542

(22) Filed: Jun. 24, 2021

(51) Int. Cl. G06Q 10/10; G06Q 10/06

(52) U.S. Cl. CPC G06Q 10/1057; G06Q 10/06311; G06Q 10/06312

(57) ABSTRACT

A method and a system for managing paid time off (PTO) data associated with employees of an employer at a workplace are provided herein. The method may include the following steps: obtaining the PTO data from at least one human resource (HR) database of said workplace; tagging the PTO data, to yield tagged PTO units based on demand and supply of the employees and the workplace; allocating respective values to the tagged PTO units in terms of benefit to the employees and to the employer; applying a cost function to said tagged PTO units, factoring said respective values, to yield an overall benefit for every possible PTO allocation plan, wherein the obtaining, the tagging, the allocating, and the applying are carried out by at least one computer processor. The system may implement the aforementioned method as a software as a service (SaaS) platform.

### FIELD OF THE INVENTION

The present invention relates generally to the field of processing and managing data records, and more particularly to processing and managing human resources data.

### BACKGROUND OF THE INVENTION

Prior to the background of the invention being set forth, it may be helpful to provide definitions of certain terms that will be used hereinafter.

The term “paid time off” as used herein is defined as a policy in some employee handbooks that provides a bank of hours in which the employer pools sick days, vacation days, and personal days that allows employees to use as the need or desire arises.

The term “recommender system”, or a recommendation system (sometimes replacing “system” with a synonym such as platform or engine), is a subclass of information filtering system that seeks to predict the “rating” or “preference” a user would give to an item.

Current paid time off policies implemented by workplaces tend to be inefficient. One reason is that employees tend to postpone taking a vacation or even asking for a vacation because of workload and other reasons. The employers, on the other hand find it hard for paid time off to be carried out from one fiscal year to another as it increases their financial liability and affects the cashflow as well as the balance sheet.

Several attempt to computerize human resources (HR) management are known in the art. These solutions are mainly directed at data representation and dashboarding of various tasks allocated to employees, as well as recording vacations and sick leaves. Currently there is no computerized solution that analyzes paid time off as a human resource and capable of optimizing its use and allocation throughout the workplace in an analytical and methodological manner.

There is a need to address the management of paid time off so that both employees and employers can have a structured manner to be aware of the potential paid time off as and consume it more effectively to improve the wellbeing of the employees as well as the financial sustainability of the workplace.

### SUMMARY OF THE INVENTION

According to some embodiments of the present invention, a method, and a system for managing paid time off (PTO) data associated with employees of an employer at a workplace are provided herein. The method may include the following steps: obtaining the PTO data from at least one human resource (HR) database of said workplace; tagging the PTO data, to yield tagged PTO units based on demand and supply of the employees and the workplace; allocating respective values to the tagged PTO units in terms of benefit to the employees and to the employer; applying a cost function to said tagged PTO units, factoring said respective values, to yield an overall benefit for every possible PTO allocation plan, wherein the obtaining, the tagging, the allocating, and the applying are carried out by at least one computer processor. The system may implement the aforementioned method as a software as a service (SaaS) platform.

These additional, and/or other aspects and/or advantages of the present invention are set forth in the detailed description which follows.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of a system for managing paid time off in accordance with embodiments of the present invention; and

FIG. 2 is a high-level flowchart illustrating non-limiting exemplary method of managing paid time off in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

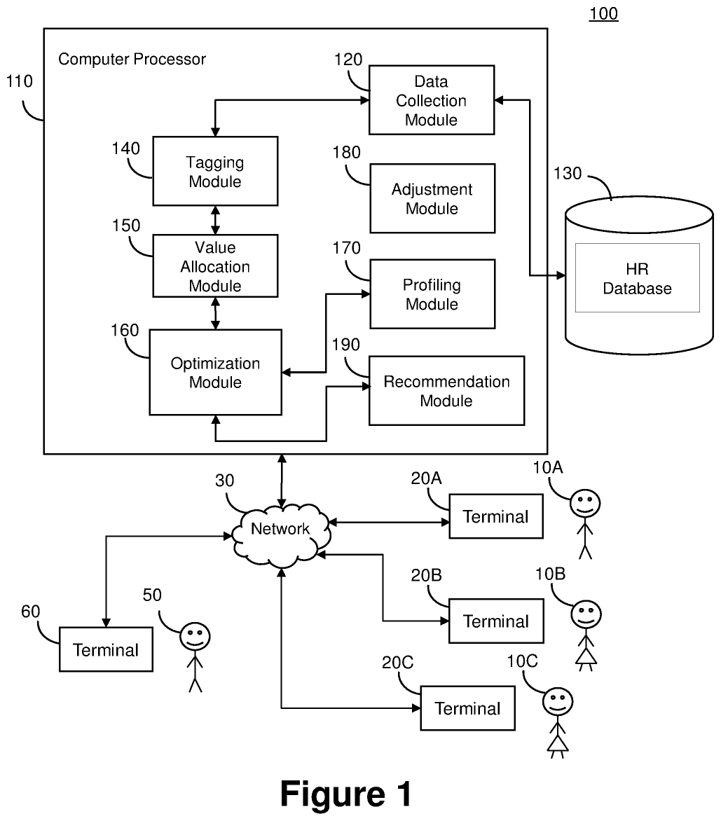

FIG. 1 is a block diagram illustrating non-limiting exemplary architecture of a system 100 for managing paid time off (PTO) data associated with employees 10A-10C of an employer 50 at a workplace. System 100 may include at least one computer processor 110 and a data collection module 120 implemented over computer processor 110 configured to obtain the PTO data from at least one human resource (HR) database 130 of the workplace.

System 100 may include a tagging module 140 implemented over computer processor 110 and configured to tag the PTO data, to yield tagged PTO units based on demand and supply of the employees and the workplace. System 100 may include a value allocation module 150 implemented over computer processor 110 and configured to allocate respective values to the tagged PTO units in terms of benefit to employees 10A-10C and to employer 50.

In accordance with some embodiments of the present invention, value allocation module 150 may take into account the tasks and workload of an employee as well as the workload on his or her direct colleagues and the needs of the workplace such as nearing deadlines and the like.

System 100 may include an optimization module 160 implemented over computer processor 110 and configured to apply a cost function to the tagged PTO units, factoring the respective values, to yield an overall benefit for every possible PTO allocation plan.

According to some embodiments of the present invention, system 100 may further include a PTO profiling module 170 configured to generate PTO profiles of employees 10A-10C based on past pattern of PTO consumption thereof, wherein the cost function is further based on the PTO profiles of employees 10A-10C. The profile may include personal preferences of an employee in taking a vacation such as: preferred time of the year, preferred length (short breaks vs. long vacations) and the like.

According to some embodiments of the present invention, system 100 may further include a graphical user interface implemented over terminal 60 associated with employer 50 and terminals 20A-20C associated with employees 10A-10C respectively. Terminals 60 and 20A-20C may be in a form of a personal computer or a smartphone running a software configured to present the amount of PTO accumulated and how it is being distributed. It can also be configured to present the overall benefit for every possible PTO allocation plan.

In accordance with some embodiments of the present invention, terminal 60 which is associated with employer 50 may provide total of PTO by all employees: how much has been carried out form previous years, how much is being allocated in the current year and how much is being consumed by whom and when. In addition, the terminal 60 which is associated with employer 50 may calculate and display the financial liabilities to each one of the employees 20A-20C and also a total calculation of the PTO liability of the organization. Advantageously, the terminal 60 may also provide via its GUI, an interactive dashboard showing various scenarios for allocating the PTO to employees 20A-20C so that an optimal allocation can be semi-automatically planned by employer 50.

According to some embodiments of the present invention, system 100 may further include an adjustment module 180 configured to adjust at least one of: the tagging of the PTO data, and the allocating of respective values to the tagged PTO units, based on input from the employer, and re-apply the cost function to the tagged PTO units after said adjusting, to yield an adjusted overall benefit for every possible PTO allocation plan.

According to some embodiments of the present invention, system 100 may further include a recommendation module 190 configured to generate a recommendation to at least one of the employees 10A-10C via their terminals 20A-20C, regarding a possible PTO allocation plan associated therewith.

According to some embodiments of the present invention, the generating of the PTO profiles may include a step of considering at least one of: preferences of the employees 20A-20C and load balancing requirement of the employer 50.

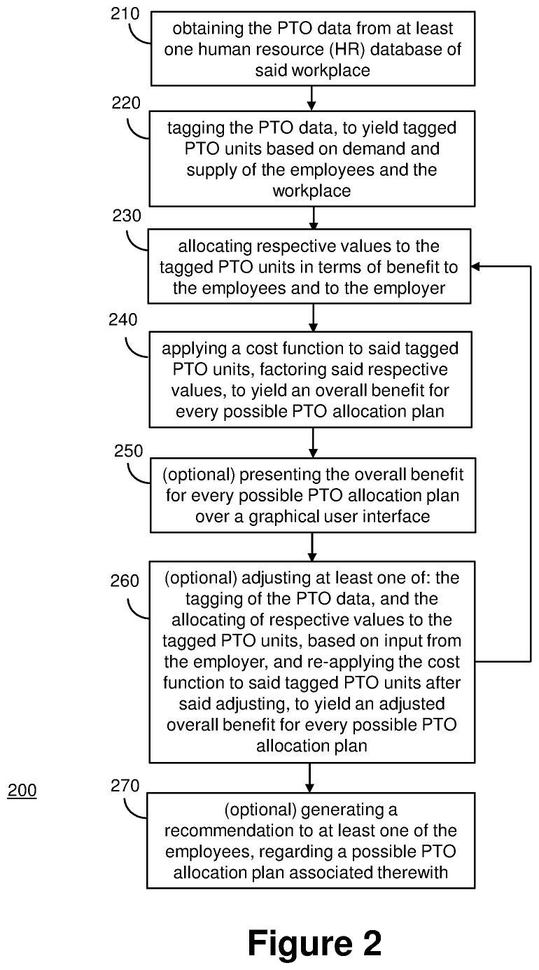

FIG. 2 is a high-level flowchart illustrating non-limiting exemplary method in accordance with embodiments of the present invention. Method 200 of managing paid time off (PTO) data associated with employees of an employer at a workplace may include the steps of: obtaining the PTO data from at least one human resource (HR) database of said workplace 210; tagging the PTO data, to yield tagged PTO units based on demand and supply of the employees and the workplace 220; allocating respective values to the tagged PTO units in terms of benefit to the employees and to the employer 230; and applying a cost function to said tagged PTO units, factoring said respective values, to yield an overall benefit for every possible PTO allocation plan 240. The aforementioned steps of the obtaining, the tagging, the allocating, and the applying are carried out by at least one computer processor.

According to some embodiments of the present invention, method 200 may optionally include a step of generating PTO profiles of the employees based on past pattern of PTO consumption thereof, wherein the cost function is further based on the PTO profiles of the employees 250.

According to some embodiments of the present invention, method 200 may optionally include a step of presenting the overall benefit for every possible PTO allocation plan over a graphical user interface 260.

According to some embodiments of the present invention, method 200 may optionally include a step of adjusting at least one of: the tagging of the PTO data, and the allocating of respective values to the tagged PTO units, based on input from the employer, and re-applying the cost function to said tagged PTO units after said adjusting, to yield an adjusted overall benefit for every possible PTO allocation plan 260.

According to some embodiments of the present invention, method 200 may optionally include a step of generating a recommendation to at least one of the employees, regarding a possible PTO allocation plan associated therewith 270.

It should be noted that method 200 according to embodiments of the present invention may be stored as instructions in a computer readable medium to cause processors, such as central processing units (CPU) to perform the method. Additionally, the method described in the present disclosure can be stored as instructions in a non-transitory computer readable medium, such as storage devices which may include hard disk drives, solid state drives, flash memories, and the like. Additionally, non-transitory computer readable medium can be memory units.

In order to implement the method according to embodiments of the present invention, a computer processor may receive instructions and data from a read-only memory or a random-access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, JavaScript Object Notation (JSON), C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment”, “an embodiment”, or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps, or integers.

If the specification or claims refer to “an additional” element, that does not preclude there being more than one of the additional elements.

It is to be understood that where the claims or specification refer to “a” or “an” element, such reference is not construed that there is only one of that elements.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of managing paid time off (PTO) data associated with employees of an employer at a workplace, the method comprising:
obtaining the PTO data from at least one human resource (HR) database of said workplace;
tagging the PTO data, to yield tagged PTO units based on demand and supply of the employees and the workplace;
allocating respective values to the tagged PTO units in terms of benefit to the employees and to the employer;
applying a cost function to said tagged PTO units, factoring said respective values, to yield an overall benefit for every possible PTO allocation plan,
wherein the obtaining, the tagging, the allocating, and the applying are carried out by at least one computer processor.

2. The method according to claim 1, further comprising generating PTO profiles of the employees based on past pattern of PTO consumption thereof, wherein the cost function is further based on the PTO profiles of the employees.

3. The method according to claim 1, further comprising presenting the overall benefit for every possible PTO allocation plan over a graphical user interface.

4. The method according to claim 1, further comprising adjusting at least one of: the tagging of the PTO data, and the allocating of respective values to the tagged PTO units, based on input from the employer, and re-applying the cost function to said tagged PTO units after said adjusting, to yield an adjusted overall benefit for every possible PTO allocation plan.

5. The method according to claim 1, further comprising generating a recommendation to at least one of the employees, regarding a possible PTO allocation plan associated therewith.

6. The method according to claim 2, wherein the generating of the PTO profiles comprises considering at least one of: preferences of the employees and load balancing requirement of the employer.

7. A system for managing paid time off (PTO) data associated with employees of an employer at a workplace, the method comprising:
at least one computer processor;
a data collection module configured to obtain the PTO data from at least one human resource (HR) database of said workplace;
a tagging module configured to tag the PTO data, to yield tagged PTO units based on demand and supply of the employees and the workplace;
a value allocation module configured to allocate respective values to the tagged PTO units in terms of benefit to the employees and to the employer;
an optimization module configured to applying a cost function to said tagged PTO units, factoring said respective values, to yield an overall benefit for every possible PTO allocation plan,
wherein the data collection, tagging module, the value allocation module, and the optimization module are implemented over the least one computer processor.

8. The system according to claim 7, further comprising a PTO profiling module configured to generate PTO profiles of the employees based on past pattern of PTO consumption thereof, wherein the cost function is further based on the PTO profiles of the employees.

9. The system according to claim 7, further comprising a graphical user interface implemented over a display and configured to present the overall benefit for every possible PTO allocation plan.

10. The system according to claim 7, further comprising an adjustment module configured to adjust at least one of: the tagging of the PTO data, and the allocating of respective values to the tagged PTO units, based on input from the employer, and re-applying the cost function to said tagged PTO units after said adjusting, to yield an adjusted overall benefit for every possible PTO allocation plan.

11. The system according to claim 7, further comprising a recommendation module configured to generate a recommendation to at least one of the employees, regarding a possible PTO allocation plan associated therewith.

12. The system according to claim 8, wherein the generating of the PTO profiles comprises considering at least one of: preferences of the employees and load balancing requirement of the employer.

13. A non-transitory computer readable medium for managing paid time off (PTO) data associated with employees of an employer at a workplace, the computer readable medium comprising a set of instructions that when executed cause at least one computer processor to:
obtain the PTO data from at least one human resource (HR) database of said workplace;
tag the PTO data, to yield tagged PTO units based on demand and supply of the employees and the workplace;
allocate respective values to the tagged PTO units in terms of benefit to the employees and to the employer; and
apply a cost function to said tagged PTO units, factoring said respective values, to yield an overall benefit for every possible PTO allocation plan.

14. The method according to claim 1, further comprising generating PTO profiles of the employees based on past pattern of PTO consumption thereof, wherein the cost function is further based on the PTO profiles of the employees.

15. The method according to claim 1, further comprising presenting the overall benefit for every possible PTO allocation plan over a graphical user interface.

16. The method according to claim 1, further comprising adjusting at least one of: the tagging of the PTO data, and the allocating of respective values to the tagged PTO units, based on input from the employer, and re-applying the cost function to said tagged PTO units after said adjusting, to yield an adjusted overall benefit for every possible PTO allocation plan.

17. The method according to claim 1, further comprising generating a recommendation to at least one of the employees, regarding a possible PTO allocation plan associated therewith.

18. The method according to claim 2, wherein the generating of the PTO profiles comprises considering at least one of: preferences of the employees and load balancing requirement of the employer.
